(19) United States
(12) Patent Application Publication
(10) Pub. No.: US 2025/0238656 A1
(43) Pub. Date: Jul. 24, 2025

(54) MULTIOMOAL EMOTION RECOGNITION SYSTEM WITH EDGE AI ACCELERATOR

(71) Applicant: Intelligent Information Security Technology Inc., Hsinchu (TW)

(72) Inventors: Wai-Chi Fang, Hsinchu (TW); Yi-Kai Chen, Hsinchu (TW)

(21) Appl. No.: 18/905,139

(22) Filed: Oct. 2, 2024

Related U.S. Application Data
(60) Provisional application No. 63/623,801, filed on Jan. 22, 2024.

(51) Int. Cl. G06N 3/043; G06N 3/0442; G06N 3/045; G06N 3/0464; G06N 3/048

(52) U.S. Cl. CPC G06N 3/043; G06N 3/0442; G06N 3/045; G06N 3/0464; G06N 3/048

(57) ABSTRACT

The present invention relates a multimodal emotion recognition system with edge AI accelerator. The system employs a Fuzzy Long-Short Recurrent Convolutional Network (Fuzzy LRCN) for multiple emotion classifications. The algorithm strategically utilizes only eight channels of electroencephalogram (EEG) signals and combines electrocardiogram (ECG) and photoplethysmogram (PPG) through a fuzzification engine to improve emotion recognition accuracy with minimal hardware resource consumption. The goal is to optimize hardware resource utilization, reduce system power consumption, and maximize emotion recognition accuracy. The fuzzy algorithm provides a lightweight multimodal AI model to address the issue of increased computational load caused by recognizing emotions from multiple signals.

The present application claims the benefit of U.S. Patent Application No. 63/623,801 filed on Jan. 22, 2024, the contents of which are incorporated herein by reference in their entirety.

### TECHNICAL FIELD

The present invention relates to a multimodal emotion recognition system with an edge AI accelerator, in particular to a multimodal emotion recognition system that maximizes the accuracy of emotion recognition.

### BACKGROUND

In recent years, in the field of research on the application of human physiological signals, emotion recognition has become the most popular research field that can be combined with various artificial intelligence models for machine learning. In addition, the emergence of Artificial Intelligence Internet of Things (AIoT) has also affected the healthcare industry, such as smart medical care, long-term care, and remote medical diagnosis. With the development of artificial intelligence, physiological signals have made deeper breakthroughs in emotional recognition.

The synergy between Artificial Intelligence (AI) and the Internet of Things (IoT) has been a driving force behind the enhancement of medical devices. With the aid of edge computing and streamlined hardware design, the efficiency of medical applications has significantly improved, latency has been reduced, mobility has increased, and energy consumption has been minimized. However, when using AI to achieve mobile remote emotion recognition, a series of unique challenges arise, particularly the need for real-time detection of dynamic emotional states. This necessitates the development of accurate and efficient edge AI algorithms and designs.

Traditional artificial intelligence neural networks perform exceptionally well in providing highly accurate results; however, they encounter certain obstacles when applied to the field of networked edge computing. Efficient processing of deep neural networks (DNNs) requires consideration of factors such as accuracy, robustness, power consumption and energy efficiency, high throughput, low latency, and hardware costs.

In conclusion, in order to overcome the aforementioned shortcomings, the inventors of the present application have devoted significant research and development efforts and spirit, continuously breaking through and innovating in the present field. It is hoped that novel technological means can be used to address the deficiencies in practice, not only bringing about better products to society but also promoting industrial development.

### SUMMARY

The primary objective of the invention is to provide a multimodal emotion recognition system with an edge AI accelerator. The system uses eight EEG channels most relevant to emotions—FP1, FP2, F3, F4, F7, F8, T3, and T4 to represent two types of emotional recognition states based on the valence and arousal dimensional model, as well as three types of emotions based on discrete classification. Additionally, the invention employs a Fuzzy LRCN classifier to mitigate the excessive hardware resource demands caused by multimodal signals. The invention also includes the design of an AI accelerator with high data reuse. Moreover, the multiply-accumulate operations of the convolutional layers, dense layers, and LSTM layers are integrated into the same hardware to enable hardware sharing. Furthermore, the proposed model is evaluated using a rigorous Leave-One-Subtopic-Out Validation (LOSOV), a commonly used method for cross-subject analysis. The baseline normalization technique effectively improves the average accuracy of LOSOV.

To achieve the above-mentioned objectives, the present invention provides a multimodal emotion recognition system with edge AI accelerator, comprising: a database, a processor, an edge AI accelerator and an electronic device. The database includes at least one physiological dataset, which contains a plurality of physiological signal data, including a plurality of electroencephalography, a plurality of electrocardiogram and a plurality of photoplethysmogram. Further, the processor is communicatively connected to the database and includes at least one first feature extraction module and a second feature extraction module. The first feature extraction module extracts a plurality of first feature maps from a first training dataset obtained from the database, and the second feature extraction module extracts a plurality of second feature maps from a second training dataset obtained from the database. Moreover, the edge AI accelerator is communicatively connected to the processor through an interface to receive the first feature maps and the second feature maps, the first feature maps are utilized to train a Long-term Recurrent Convolutional Neural Network (LRCN) prediction model to obtain an initial training result, while the second feature maps are processed through a fuzzy algorithm of a nearest prototype classifier to generate an identification signal, which is used to adjust the initial training results, and an emotion recognition result is produced through a Softmax layer. Additionally, the electronic device is communicatively connected to the processor through the interface and is used to display the emotion recognition result and a trained fuzzy LRCN prediction mode.

Furthermore, the edge AI accelerator includes: a data memory unit, a processing array unit, a convolutional neural network acceleration unit, a Long Short-Term Memory unit and a fully connected unit. The data memory unit stores the processed first feature maps, the second feature maps or an emotion recognition result, and provides relevant commands to reset or input data to the processor. The processing array unit is composed of a plurality of processing units, each containing a first multiply-accumulate (MAC) unit to perform computations for convolutional operations and matrix-vector product, enabling performing parallel processing of the first feature maps and the second feature maps. Moreover, the convolutional neural network (CNN) acceleration unit includes a plurality of convolutional layers and a plurality of pooling layers. The convolutional layers perform a convolution operation on the first feature maps and control the convolution operations in the processing array unit to generate convolution data. The pooling layers perform a pooling operation on the convolution data to reduce computational complexity, controlling the pooling operations in the processing array unit to generate a pooled data. Additionally, the Long Short-Term Memory (LSTM) unit performs recursive processing on the pooled data, extracting temporal features with each processing unit to generate a recursive data. The fully connected unit performs regression prediction, while the recursive data performs a matrix-vector product operation with each processing unit of the processing array unit. The controls the multiplication operation of the processing array unit to obtain the emotion recognition result.

In the multimodal emotion recognition system of the present invention, an AI hardware acceleration architecture with high data reuse is used. By integrating convolution operations and vector multiplication operations, commonly used neural network components such as convolutional layers, fully connected units, and Long Short-Term Memory (LSTM) layers are further integrated and implemented with hardware sharing to achieve high energy efficiency. The entire emotion recognition system is ultimately controlled by a RISC-V processor, which serves as the control center. The RISC-V processor also participates in the computation of feature extraction. The recognition model is accelerated by the AI hardware accelerator designed in this research, achieving high energy efficiency and low hardware resource requirements.

### BRIEF DESCRIPTION OF THE DRAWINGS

FIG. 1 is a schematic diagram of a multimodal emotion recognition system of the present invention.

FIG. 2 is a data processing flow of the multimodal emotion recognition system of the present invention.

FIG. 3 is an architecture of a Fuzzy LRCN system of the present invention.

FIG. 4 is a model of the Fuzzy LRCN system of the present invention.

FIG. 5 is a block diagram of the edge AI accelerator architecture of the present invention.

FIG. 6 is a schematic diagram of the data flow in the processing array unit of the present invention.

FIG. 7 is a schematic diagram of the hardware architecture for convolution operations of the present invention.

FIG. 8 is the experimental flowchart of the KMU dataset in the present invention.

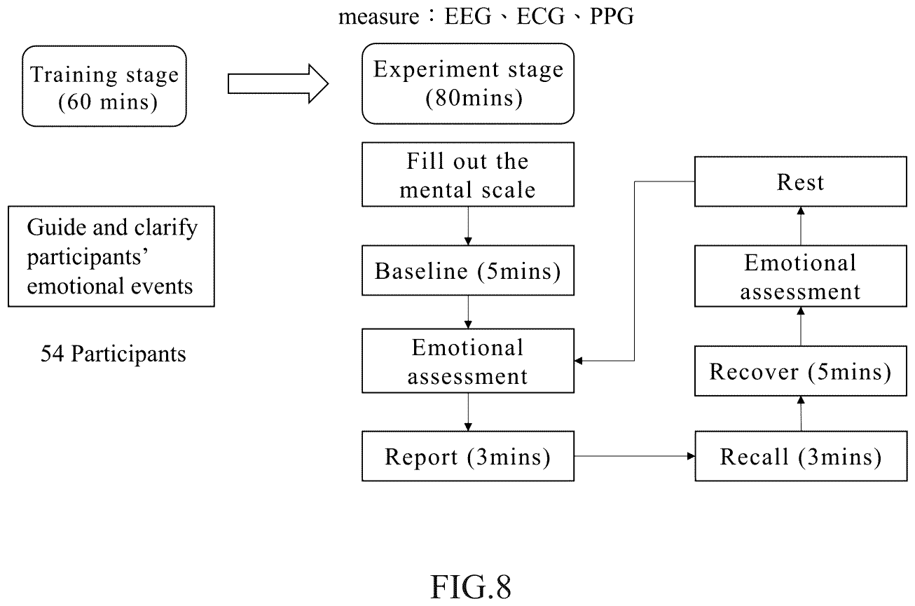

FIG. 9 is a bar chart of the accuracy of emotion valence recognition results using the DEAP dataset in the present invention.

FIG. 10 is a bar chart of the accuracy of arousal recognition results using the DEAP dataset in the present invention.

FIG. 11 is a bar chart comparing the general LRCN and Fuzzy LRCN models for subjects 2 to 26 in the two-class emotion recognition methods of the present invention.

FIG. 12 is a bar chart comparing the general LRCN and Fuzzy LRCN models for subjects 27 to 52 in the two-class emotion recognition methods of the present invention.

FIG. 13 is a bar chart comparing the general LRCN, binary-class Fuzzy LRCN, and ternary-class Fuzzy LRCN models for subjects 2 to 18 in the three-class emotion recognition methods of the present invention.

FIG. 14 is a bar chart comparing a general LRCN, binary-class Fuzzy LRCN, and ternary-class Fuzzy LRCN models for subjects 19 to 34 in the three-class emotion recognition methods of the present invention.

FIG. 15 is a bar chart comparing the general LRCN, binary-class Fuzzy LRCN, and ternary-class Fuzzy LRCN models for subjects 35 to 52 in the three-class emotion recognition methods of the present invention

### DETAILED DESCRIPTION

In order to enable a person skilled in the art to better understand the objectives, technical features, and advantages of the invention and to implement it, the invention is further elucidated by accompanying appended drawings. This specifically clarifies the technical features and embodiments of the invention, and enumerates exemplary scenarios. To convey the meaning related to the features of the invention, the corresponding drawings herein below are not and do not need to be completely drawn according to the actual situation.

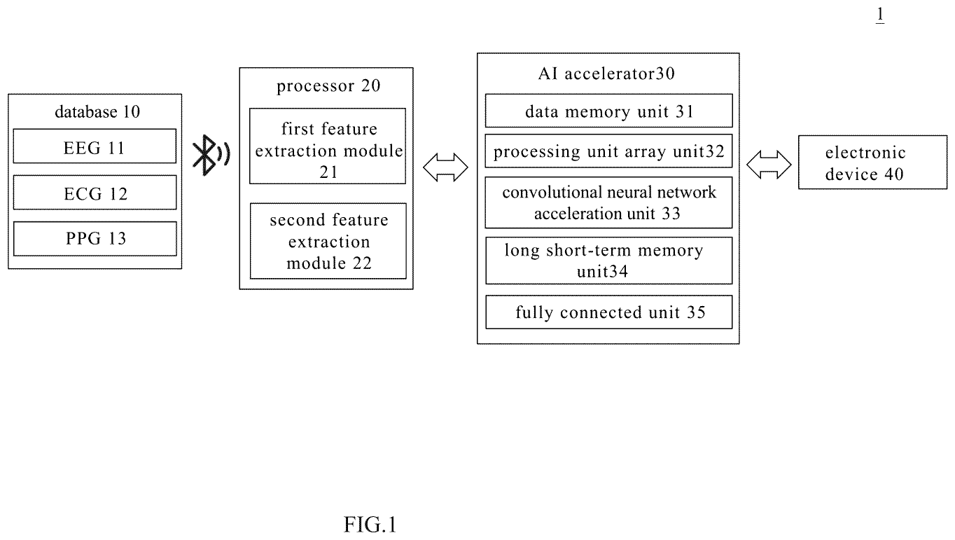

As shown in FIG. 1, the present invention provides a multimodal emotion recognition system 1 with edge AI accelerator, comprising: a database 10, a processor 20, an edge AI accelerator 30 and an electronic device 40.

The database 10 includes at least one physiological dataset, which contains a plurality of physiological signal data obtained through a front-end sensor 10a. The physiological signal data includes a plurality of electroencephalography 11, a plurality of electrocardiogram 12 and a plurality of photoplethysmogram 13; wherein the electroencephalogram (EEG) is used to record the electrical activity of neurons in the brain, and the measured parameters include location, frequency range, amplitude, and waveform. Additionally, the electrocardiogram (ECG) is used to record the heart's electrical activity over a period of time. During each heartbeat, the depolarization of cardiac muscle cells causes small electrical changes on the surface of the skin. These small changes are captured and amplified by the ECG recording device to display the electrocardiogram. In addition, the photoplethysmogram (PPG) 13 is used to measure changes in blood volume within peripheral blood vessels. Typically, it involves placing a light source (usually an LED) and a photodetector on the skin to monitor the amount of light absorbed by the underlying tissue.

Furthermore, through wearable wireless monitoring devices, the electroencephalogram (EEG), the electrocardiogram (ECG), and the photoplethysmogram (PPG) are monitored. The EEG, being a non-invasive and cost-effective technology, is used to monitor brain signals. The invention selects a dry electrode EEG headset and reduces the number of EEG channels to 8 after performing channel selection analysis. The ECG signal is recorded using a 4-lead configuration, with electrode patches attached to the right upper, left upper, right lower, and left lower positions on the body.

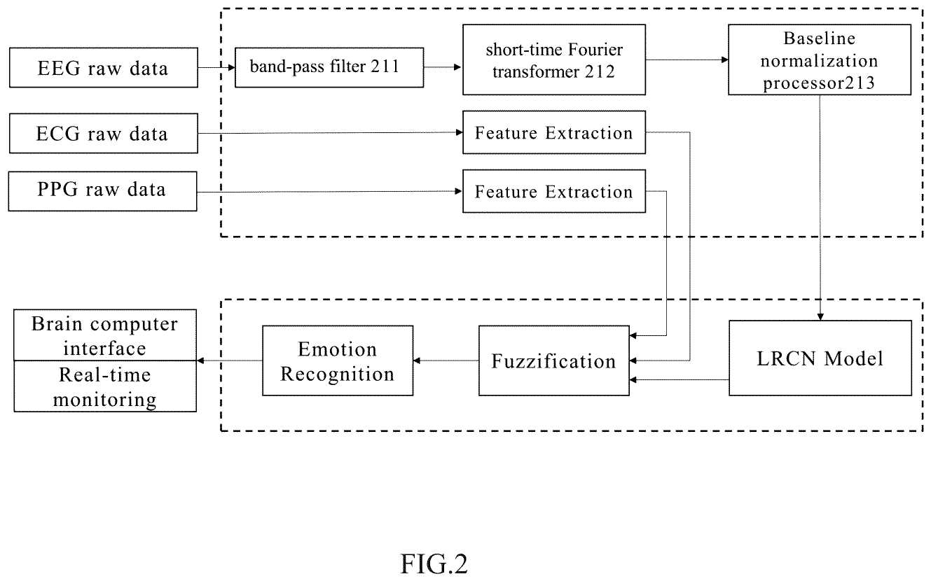

As shown in FIGS. 1 and 2, the processor 20 is a processor based on the fifth-generation Reduced Instruction Set Computer (RISC-V) architecture. The processor 20 is connected to the database 10 via Bluetooth wireless communication and includes at least a first feature extraction module 21 and a second feature extraction module 22. The first feature extraction module 21 is used to extract a plurality of first feature maps from a first training dataset obtained from the database 10, while the second feature extraction module 22 extracts a plurality of second feature maps from a second training dataset obtained from the database 10.

The first feature extraction module 21 includes a band-pass filter 211, a short-time Fourier transformer 212 and a baseline normalization processor 213. The brainwave signals from the 8 channels, namely FP1, FP2, F3, F4, F7, F8, T3, and T4, are processed using the same feature extraction algorithm applied to the signals from all 8 channels, thereby reducing the computational complexity of preprocessing. The band-pass filter 211 captures brainwave signals in the 8-45 Hz range. In EEG signals, the frequency ranges highly correlated with emotions are classified as α waves (8-13 Hz), β waves (14-30 Hz), and γ waves (>30 Hz). Subsequently, the short-time Fourier transform is used to extract a frequency signal from the at least one physiological signal, with features extracted every second using a non-overlapping Hamming window. The final size of the spectrogram obtained after STFT calculation is 38×8, which is also the input size for the subsequent LRCN recognition model. Additionally, the baseline normalization processor scales each data point based on a mean value using the following Equation 1,

$${Spec}_{i}^{{′}_{ch}} = \frac{{Spec}_{i}^{{′}_{ch}} - {baseline}^{ch}}{{baseline}^{ch}} , \qquad Equation 1$$

where Spec and Spec′ represent the data before and after baseline normalization processing, respectively; ch is the EEG channel, and i denotes the number of subjects.

Furthermore, the second feature extraction module includes a plurality of feature values between peak-to-peak intervals (R-R Interval, RRI) of ECG and peak-to-peak intervals of PPG, and the feature values includes SDNN, NN50, PNN50, RMSSD, δx, δ′, γx, γ′, SDSD, SD1, SD2, SD12, PTTₘₑₐₙ, PTT_{std}, PPGₘₑₐₙ, PPG_{std}, LF, HF, LF/HF, and HF/TP. Directly extract a small number of features from the original ECG and PPG signals to reduce computational complexity. Please refer to Table 1.

TABLE 1

| Feature | Description |
|---|---|
| SDNN | Standard deviation of RR interval (RRI) |
| NN50 | The total number of absolute values of the distance difference between |
| | adjacent RRI greater than 50 ms |
| PNN50 | NN50/total number of RRI |
| RMSSD | Root mean square of adjacent RRI |
| δₓ | Average of absolute difference between adjacent RRI |
| δ′ₓ | Average of absolute difference between adjacent normalized RRI |
| γₓ | Average of absolute difference of every two RRI |
| γ′ₓ | Average of absolute difference of every two normalized RRI |
| SDSD | Standard deviation of difference between adjacent RRI |
| SD1 | Short time variation of the RRI |
| SD2 | Long time variation of the RRI |
| SD12 | Short time versus long time variation of the RRI |
| PTTₘₑₐₙ | Average of Pulse Transit Time (PPT) |
| PTT_{std} | Standard deviation of Pulse Transit Time (PPT) |
| PPGₘₑₐₙ | Average of PPG signal peak |
| PPG_{std} | Standard deviation of PPG signal peak |
| LF | The power of low frequency band from ECG signal (0.04-0.15 Hz) |
| HF | The power of high frequency band from ECG signal (0.15-0.4 Hz) |
| TP | Total power of EEG signal (0-0.4 Hz) |

By combining the features from the ECG and PPG with a fuzzy nearest prototype classifier, assistance is provided to the LRCN prediction model for recognition. Therefore, an algorithm is needed to quantize all training samples. The Generalized Learning Vector Quantization (GLVQ) algorithm is used to quantize the feature values, assigning them to predefined categories. GLVQ represents the differences between categories as a weight matrix, allowing the nearest prototype classifier to adjust the weights to distinguish the emotion recognition results.

An input value to the nearest prototype classifier consists of a training dataset and test dataset, where the training dataset is W={Z₁, Z₂, . . . , Z_{c}}, with Zᵢ is the set of prototype representing in ith classes, and an output value of the nearest prototype classifier including a distance between a test sample and all training samples, a membership value, and a predicted label. The membership value is calculated using a membership function, which is defined by the following formula:

$${μ}_{i} ( x ) = \frac{1 / {\vert {x}_{test} - {Z}_{i} \vert}^{2 / ( m - 1 )}}{{\sum }_{j = 1}^{c} ( 1 / {\vert {x}_{test} - {Z}_{j} \vert}^{2 / ( m - 1 )}} . \qquad Equation 2$$

The edge AI accelerator 30 is communicatively connected to the processor 20 through an interface 301 to receive the first feature maps and the second feature maps, the first feature maps are utilized to train a Long-term Recurrent Convolutional Neural Network (LRCN) prediction model to obtain an initial training result, the second feature maps are processed through a fuzzy algorithm of a nearest prototype classifier to generate an identification signal, which is used to adjust the initial training results, and an emotion recognition result is produced through a Softmax layer.

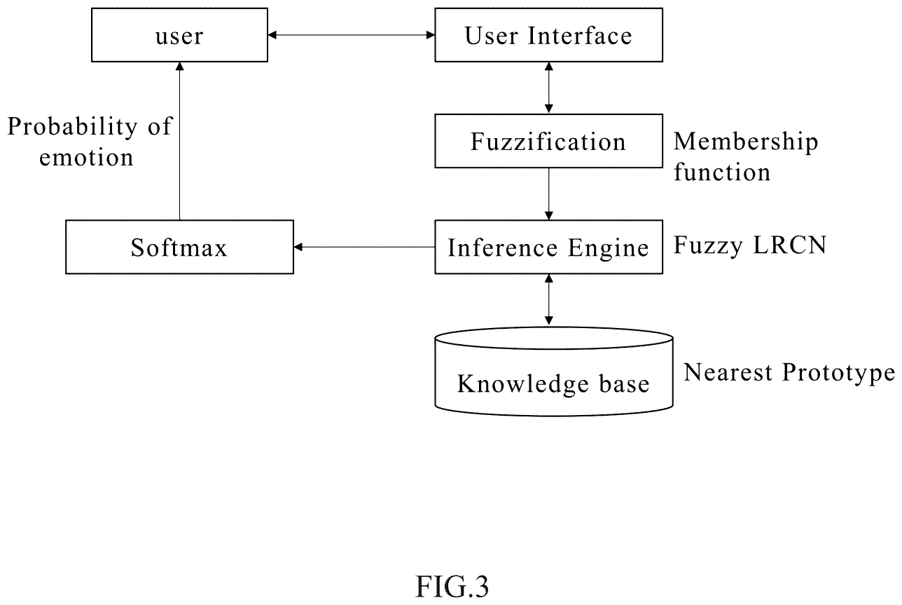

As shown in FIG. 3, combining fuzzification with the LRCN prediction model, first, input the second feature maps and apply the membership function from Formula 2. Next, perform fuzzification knowledge base using GLVQ to quantize the second feature maps, and then use the nearest prototype classifier for recognition. Next, perform fuzzy inference engine, for the mapping of fuzzy input to fuzzy output, using the fuzzy LRCN architecture. It involves correcting the LRCN recognition results of the EEG signals based on the second feature maps, and then producing the output. Additionally, the softmax function commonly used in neural networks is employed instead of defuzzification to obtain the probabilities for different emotions. Finally, classification is based on the highest probability. After modifying the general fuzzy system, the structure of the LRCN prediction model is adjusted to integrate the information from the second feature map.

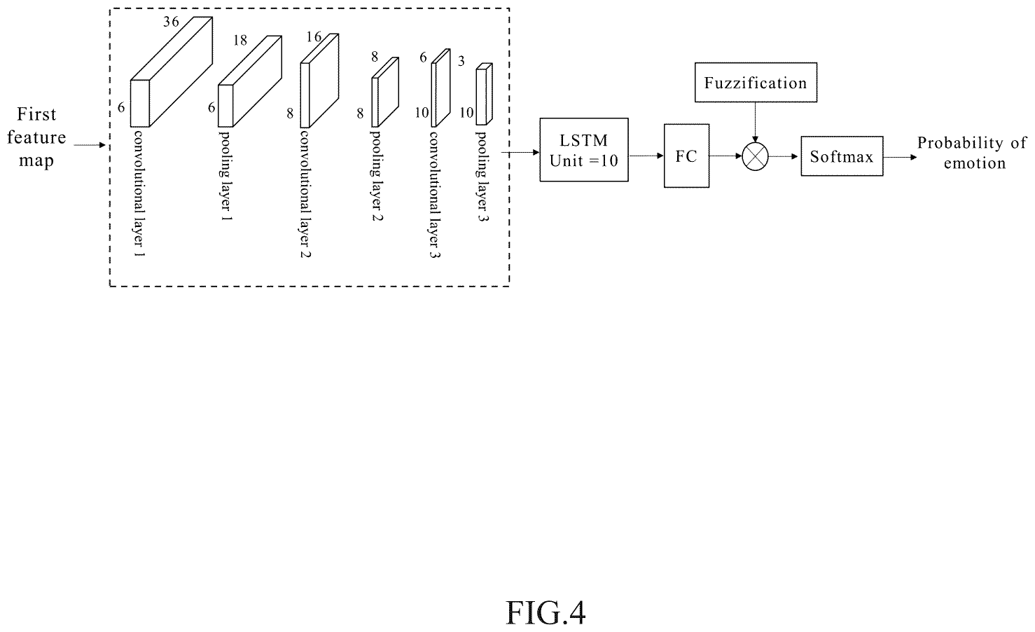

As shown in FIG. 4, for the data processing path of the first feature maps, there is no change from the first convolutional layer to the fully connected unit. The output of the fully connected unit is then multiplied by the membership degrees for each category obtained during the fuzzification process. The membership degrees, calculated from Formula 2, come from the second feature maps. The probabilities for different emotions are then classified using softmax. In other words, if the membership degree for the ‘happy’ classification based on the second feature maps is 0.95, it will nearly not change the LRCN model's output for ‘happy’. If the membership degree for ‘happy’ is 0.05, it will reduce the proportion of the LRCN model's output for ‘happy’, thus correcting the final probability value. Additionally, by modifying the constant parameter m in Formula 2, the sensitivity of the second feature maps to the membership degrees can be adjusted. In a preferred embodiment, the constant m is set to 2.

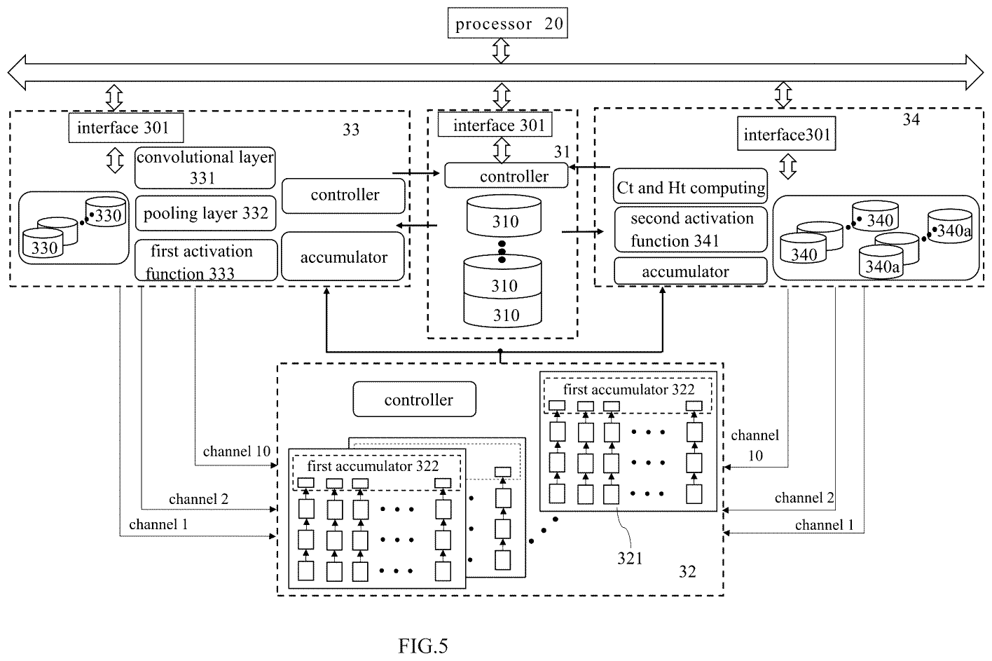

As shown in FIGS. 1 and 5, the edge AI accelerator 30 includes a data memory unit 31, a processing array unit 32, a convolutional neural network (CNN) acceleration unit 33, a Long Short-Term Memory (LSTM) unit 34, and a fully connected unit 35. The data memory unit 31 stores the processed first feature maps, the second feature maps, or an emotion recognition result, and it provides relevant commands to reset or input data to the processor 20. The data memory unit 31 includes five 1024×32 double-word weight static random access memory (SRAM) data memory 310, responsible for storing inputs and the first feature maps after each layer operation. Additionally, the memory unit 31 provides relevant instructions to the processor 20 for resetting or inputting data.

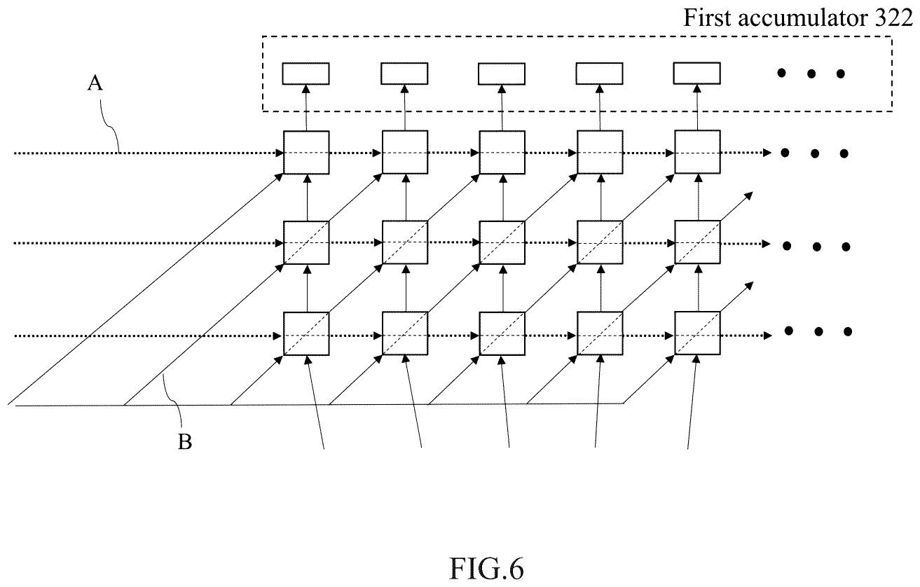

Furthermore, the processing array unit 32 is composed of a plurality of processing units 321, each contains a first product accumulator 322 that performs computations for convolutional computing and matrix-vector product, enabling parallel processing of the first feature maps and the second feature maps. Each processing array unit 32 includes 3×10 processing units, capable of processing a 3×N filter and a 12×N feature map simultaneously in a single cycle, where N represents the data length. The signal input method uses a horizontal broadcast (as shown in A of FIG. 6) and a diagonal broadcast (as shown in B of FIG. 6), allowing convolution data to be fed to a plurality of processing units 321 for product accumulation operations within one cycle to generate a product accumulation result. This result is then passed to the previous level of processing unit 321 through a vertical shift register for product accumulation operations in the next cycle, ultimately reaching an upper accumulator to obtain a convolution operation result.

The convolutional neural network acceleration unit 33 includes five weight memories 330, a plurality of convolutional layers 331 and a plurality of pooling layers 332. The weight memories are used for temporarily storing the weights required by the convolutional layers and fully connected layers. The convolutional layers 331 perform convolution operations on the first feature maps and control the convolution operations in the processing array unit 32 to generate convolution data. The pooling layers 332 perform pooling operations on the convolutional data to reduce computational load, and the pooling layers 332 control the pooling operations in the processing array unit 32 to generate convolution data a pooled data. The computations of the convolutional layers and the fully connected unit are accelerated by sending them to the processing unit array unit 32, which has the bandwidth to perform product accumulation operations on 10 input channels simultaneously. The convolutional neural network accelerator unit 33 supports the application of softmax activation function and ReLU activation function in the computations of the convolutional layer 331 or the fully connected unit.

In each convolution operation, the filter, the first feature maps and the second feature maps are independently broadcast horizontally and diagonally to the processing unit array unit 32. Using row stationarity, the product of one column of the filter and one column of the first feature maps and the second feature maps can be efficiently computed in each cycle. To prevent partial sums from influencing each other between the two sets of inputs, a cycle with zero input is inserted between consecutive convolution operations, resulting in each operation requiring W+1 cycles, where W is the width of the filter. Additionally, a tile-based method and zero-padding method are employed to handle excessively large or small inputs, including the first feature maps, the second maps and the filter. First, the hardware performs tiling and zero-padding operations for the filter, and then similar operations are performed on the first feature maps and the second feature maps. The filter processing method involves tiling for filters with a height exceeding three pixels and zero-padding for filters with less than three pixels. The zero-padding method of the convolution control unit is finely tuned with the processing engine array hardware, effectively reducing additional power consumption. The processing of the first feature maps and the second feature maps involves segmentation for heights exceeding 12 pixels based on the filter height, including tile-based overlapping. For heights less than 12 pixels, zero-padding is used.

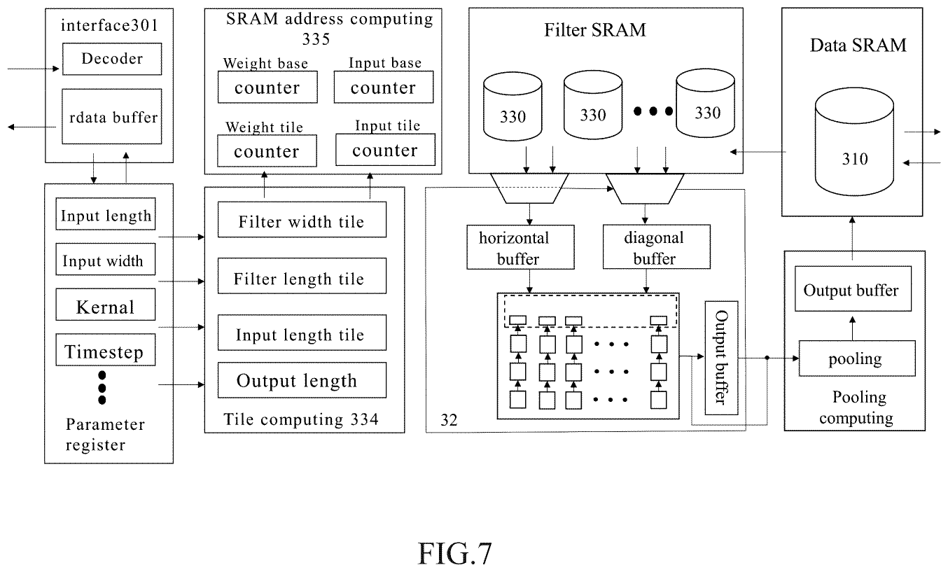

As shown in FIG. 7, all inputs and outputs are transmitted to the interface 301 via the Advanced Peripheral Bus 201. Before computation, the tile and zero-padding algorithms are executed by a tile computation module 334. Subsequently, an SRAM address computation module 335 maps the results of these two algorithms to the correct addresses in the SRAM, determining the storage locations for the filter, the first feature maps and the second feature maps. The data is then read from the data memory 310 and transmitted to the processing unit array unit 32 for convolution computation. After the convolution, max pooling is applied, with the pooling kernel size dynamically selected as 2×2 or 2×1, automatically adjusting according to whether the user's physiological feature map is a two-dimensional or one-dimensional vector. After the pooling operation, the results are stored back into the data memory 310, ready for processing by subsequent layers.

The long short-term memory (LSTM) unit 34 performs recursive processing on the pooled data, extracting temporal features through computations within each processing unit 321 to generate recursive data. The LSTM unit 34 includes a first memory 340, consisting of five 256×32 double-word SRAMs and a second memory 340a, consisting of another set of five 256×32 double-word SRAMs. The first memory 340 and the second memory 340a are used to store the weights corresponding to the first feature maps and the second feature maps, as well as the weights of the hidden states. The LSTM unit 34 performs a gate parameter computation on the pooled data, with the computation carried out in each processing array unit 32 to generate the recursive data. This data is then processed by a second activation function 341 to calculate the final current state (Ct) value and a hidden state (Ht) value.

The fully connected unit 35 performs regression prediction, where the recursive data undergoes matrix-vector multiplication in each processing unit 321 of the processing array unit 32 to produce the emotion recognition result. Additionally, the fully connected unit 35 includes an activation function, which can be either a Rectified Linear Unit (ReLU) function or a Softmax function. When the calculation of the previous layer of the fully connected unit 35 is not the final layer, the ReLU function is used as the activation function. If the fully connected unit 35 is performing the final layer's calculation, the activation function switches to the Softmax function. The result of the ReLU function can be directly determined by the sign bit and is output to the respective memory units.

The output of the fully connected unit 35 is multiplied by a membership degree of each category in the fuzzification algorithm process to obtain a multiplication value. The membership degree, calculated using Formula 2, is derived from the second feature maps of the electrocardiogram signals and the photoplethysmography signals. The multiplication value is then used to adjust the emotion recognition result generate by the Softmax layer. The electronic device 40 communicates with the processor 20 through the interface 301 and is used to display the emotion recognition result and the trained fuzzy LRCN prediction model.

For the software validation of the multimodal emotion recognition system 1 of the present invention, two datasets were used. One is a private dataset provided by Kaohsiung Medical University (KMU), which contains various physiological signals. The other is the publicly available DEAP (Database for Emotion Analysis using Physiological Signals) dataset, which is widely used in emotion recognition research. The KMU dataset is used to compare the differences between the standard LRCN and the fuzzy LRCN. On the other hand, the DEAP dataset is used to improve the reliability of the algorithm.

The DEAP dataset collection team proposes a multimodal dataset for analyzing human emotional states. Thirty-two participants had their electroencephalogram (EEG) and peripheral physiological signals recorded while they watched 40 one-minute-long music video clips. Participants rated each video based on arousal, valence, like/dislike, dominance, and familiarity. The experimental setup of the dataset began with a two-minute baseline recording, during this period, participants will see a fixed cross and are instructed to focus on the fixed cross in the center of the screen, avoid thinking about other matters or having other emotions, and relax. Subsequently, the 40 videos were presented across 40 trials, each consisting of the following elements: 1. a 2-second screen displaying the current trial number to inform participants of their progress; 2. a 5-second baseline recording (fixation cross); 3. a 1-minute display of the music video; 4. self-assessment of arousal, valence, liking, and dominance after each trial.

The KMU dataset information from 54 participants diagnosed with high cardiovascular-related risk, aged between 30 and 50 years old. Unfortunately, records for 14 participants were found to be incomplete and were therefore excluded. Finally, the KMU dataset consists of data from 40 participants for recognition purposes. The dataset collection involves two stages: the training stage and the experiment stage. In the training phase, participants are familiar with emotion recall to ensure that they can easily recall simple emotions in four emotion experiments (neutral, angry, happy, depress) induced by various stimuli such as people, events, times, places, objects, etc.

In the experiment stage, EEG, ECG, PPG, and blood pressure (BP) are recorded during the induction of mental states. Prior to emotion induction, 5 min of baseline data were recorded and participants performed self-assessments. For each emotional state, signals are collected for 11 minutes: 3 minutes for the statement period, 3 minutes for the recall period, and 5 minutes for the recovery period. The sample rate of all physiological signals is downsampled to 256 Hz for synchronization. EEG channels including FP1, FP2, F3, F4, F7, F8, T3, and T4 are employed for emotion classification. The features are extracted from ECG and PPG include SDNN, NN50, PNN50, RMSSD, δₓ, δ′ₓ, yₓ, y′ₓ, SDSD, SD1, SD2, SD12, PTTₘₑₐₙ, PTT_{std}, PPGₘₑₐₙ, PPG_{std}, LF, HF, LF/HF, HF/TP.

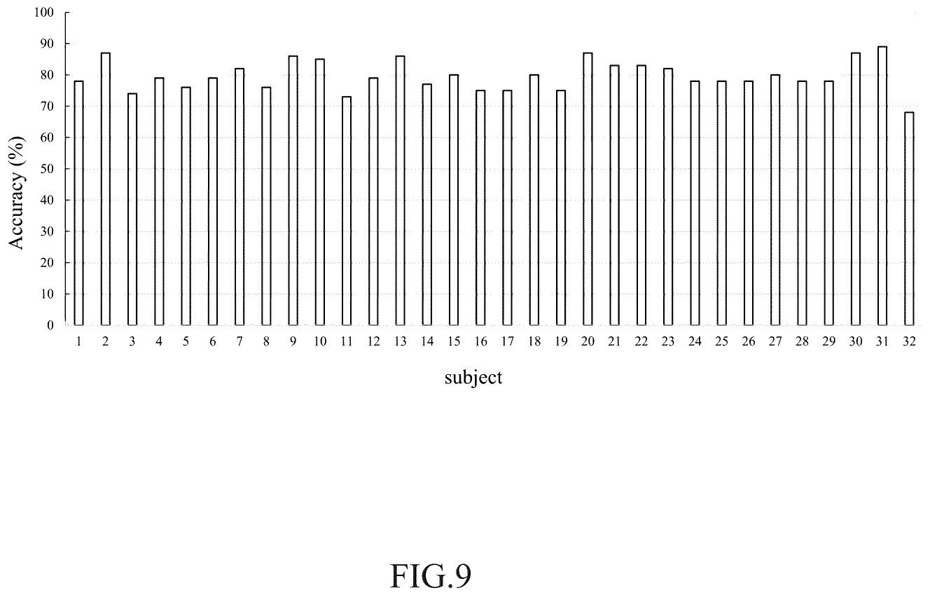

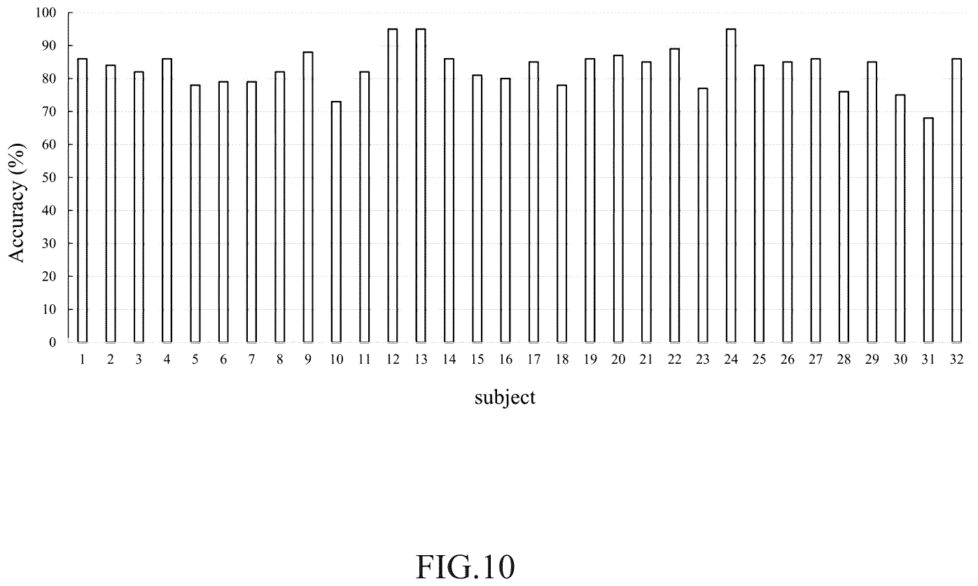

On the DEAP dataset, the total number of participants in the experiment was 32, with 16 females and 16 males. A batch size of 128 was employed for training the proposed LRCN model, which updated weights with sufficient references. The learning rate was set to 0.01, and the momentum coefficient was set to 0.001. The proposed LRCN model considered the Leave-One-Subject-Out Validation (LOSOV) strategy. Since this dataset scores valence and arousal on a scale of 1 to 9, the binary classification for both valence and arousal are performed. Scores above 5.2 were categorized as high, scores below 4.8 were categorized as low, and others were not included in the classification. Ultimately, results for high and low valence, as well as high and low arousal, were obtained. As shown in FIG. 9, in terms of valence, the average accuracy of the Fuzzy LRCN model is 79.45%. As shown in FIG. 10, for arousal, the accuracy of the Fuzzy LRCN model is 82.68%.

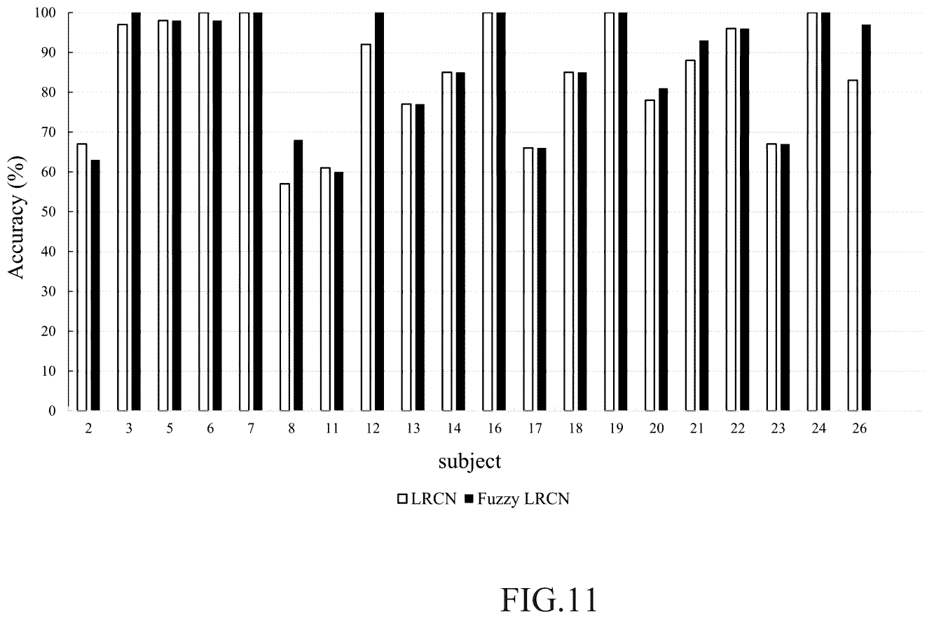

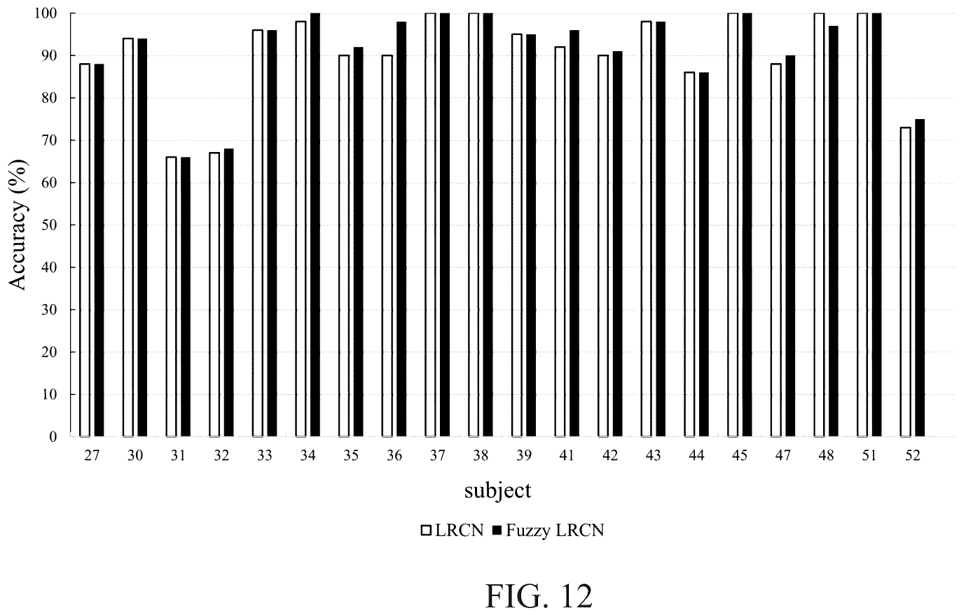

On the KMU dataset, the Fuzzy LRCN model was validated on 40 participants, providing a larger training dataset compared to other public databases. A batch size of 128 was utilized for training the proposed Fuzzy LRCN model, which updated the weights with sufficient reference. The learning rate was set to 0.01, and the momentum coefficient was set to 0.001. The KMU dataset is a discrete emotion category (including happiness, anger, depression) rather than a continuous emotional result (such as the valence and arousal scores of the DEAP dataset). Therefore, in binary classification happiness is classified as a positive state, and anger and depression as negative states. As shown in FIGS. 11 and 12, a comparison of the results between a general LRCN and a Fuzzy LRCN models. In binary classification, the General LRCN model achieved an accuracy of 88.35%, while the Fuzzy LRCN model achieved a slightly higher accuracy of 89.85%.

Fuzzy LRCN can achieve a greater improvement in accuracy in the case of three-class classification. However, as the number of classes increases, not only does the LRCN model require a higher number of parameters to be stored, but the codebook needed for Fuzzification also increases. On the other hand, the use of GLVQ for calculating during three-class training also leads to a doubling of the computational requirements due to the increased number of classes. Therefore, we first tried to examine the results without increasing the calculation and storage capacity of fuzzification. In other words, in the EEG three-category emotion recognition (happiness, anger, depression), only positive emotions (happiness) and negative emotions (anger and depression) are improved. It makes the computational complexity of fuzzification almost equal to the computational complexity of fuzzification used in binary classification emotion recognition.

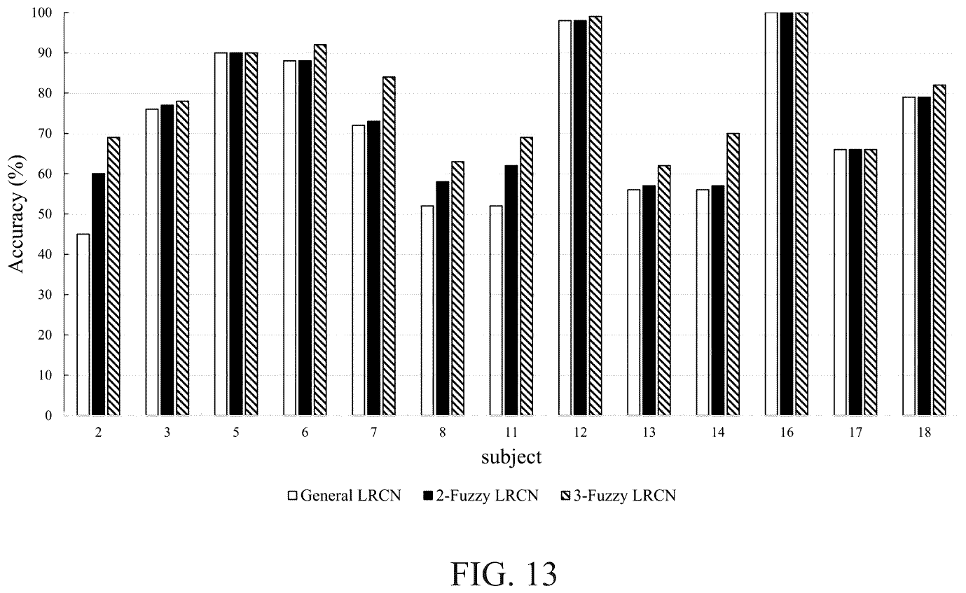

FIG. 13 shows the histograms of using binary classification fuzzification (2-Fuzzy) and three-class fuzzification (3-Fuzzy) separately to enhance three-class emotion recognition; wherein the binary classification fuzzification refers to the use of fuzzification to improve the distinction between positive and negative emotions (with negative emotions including anger and depression). Specifically, binary classification fuzzification reduces the misclassification of happiness as depression or anger, and the misclassification of anger or depression as happiness. In contrast, three-class fuzzification improves the individual misclassifications of happiness, depression, and anger. First, the use of binary classification fuzzification in three-class emotion recognition is discussed in the present invention. Using the general LRCN model, the average accuracy rate is 75.43%. On the other hand, using the 2-class Fuzzy LRCN model, the average accuracy rate is 78.14%. In comparison to algorithms that use two-class fuzzification to enhance both two-class and three-class emotion recognition separately, the improved effect on three-class emotion recognition is better. Therefore, incorporating ECG and PPG signals through additional fuzzification tends to decrease recognition accuracy. However, when trying three-class emotion recognition, many subjects such as SUB24, SUB37, SUB38, SUB51, etc. cannot achieve 100% accuracy. In such cases, the Fuzzy LRCN with the inclusion of ECG and PPG signals demonstrates improvement and yields better results.

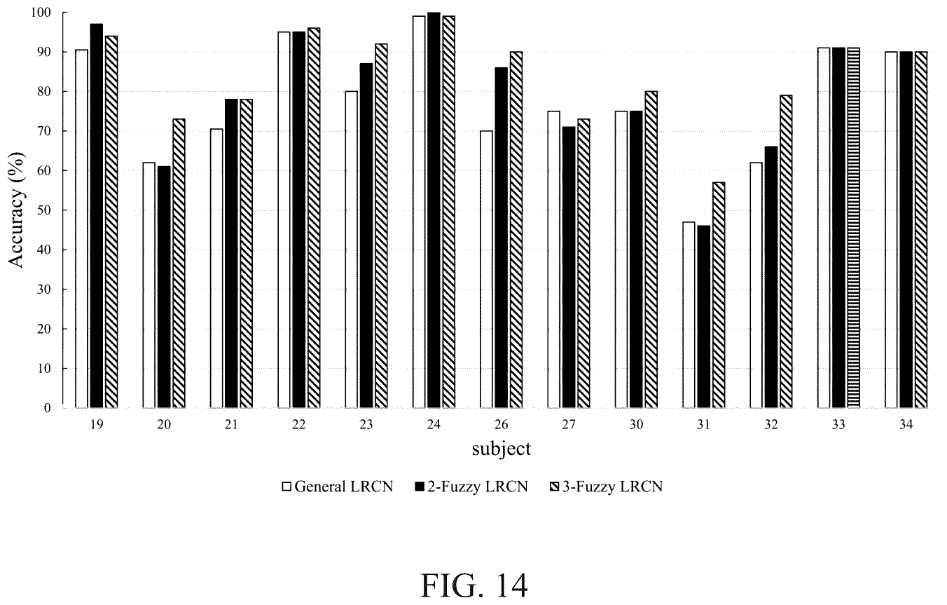

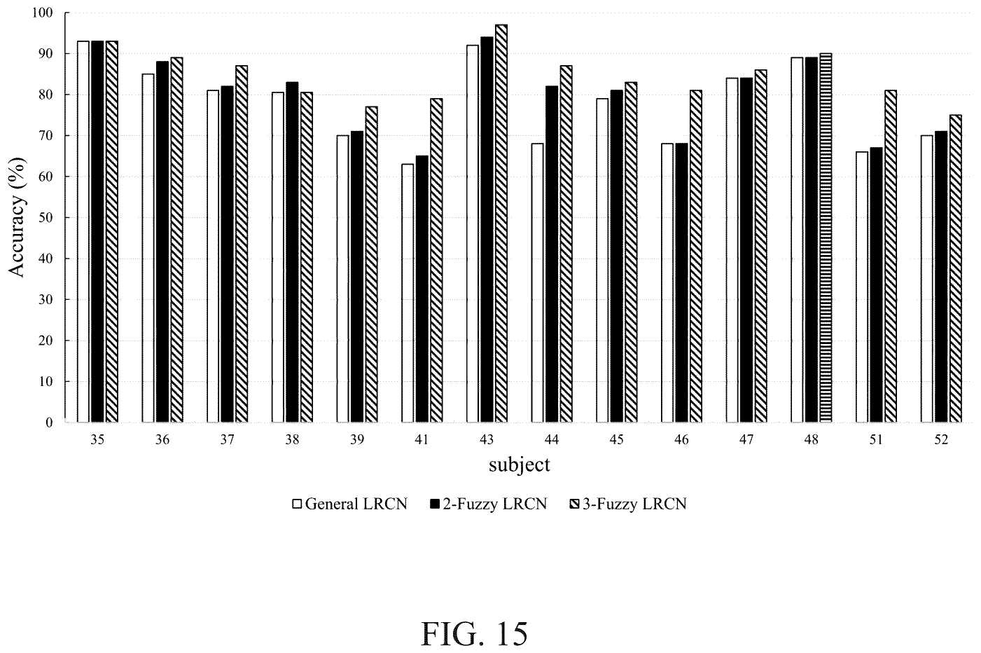

Using three-class fuzzification to enhance the results of three-class emotion recognition achieves an accuracy of 82.38%. These results demonstrate that features from ECG and PPG are relevant to emotion. The comparison results from the histogram in FIGS. 13 to 15 indicate that only a few subjects, such as SUB33, show lower accuracy in three-class fuzzification compared to two-class fuzzification. Additionally, subjects that originally had lower accuracy using two-class fuzzification than the general LRCN have shown improvement after adopting three-class fuzzification.

In order to enable the objective, technical features and advantages of the invention to be more understood by a person skilled in the art to implement the invention, the invention is further illustrated by accompanying the appended drawings, specifically clarifying technical features and embodiments of the invention, and enumerating better examples. In order to express the meaning related to the features of the invention, the corresponding drawings herein below are not and do not need to be completely drawn according to the actual situation.

What is claimed is:

1. A multimodal emotion recognition system with edge AI accelerator, comprising:
a database including at least one physiological dataset, which contains a plurality of physiological signal data, including a plurality of electroencephalography, a plurality of electrocardiogram and a plurality of photoplethysmogram;
a processor communicatively connected to the database and including at least one first feature extraction module and a second feature extraction module; wherein the first feature extraction module extracts a plurality of first feature maps from a first training dataset obtained from the database, and the second feature extraction module extracts a plurality of second feature maps from a second training dataset obtained from the database;
an edge AI accelerator communicatively connected to the processor through an interface to receive the first feature maps and the second feature maps, the first feature maps utilized to train a Long-term Recurrent Convolutional Neural Network (LRCN) prediction model to obtain an initial training result, the second feature maps processed through a fuzzy algorithm of a nearest prototype classifier to generate an identification signal, which is used to adjust the initial training results, and an emotion recognition result is produced through a Softmax layer; and
an electronic device communicatively connected to the processor through the interface, used to display the emotion recognition result and a trained fuzzy LRCN prediction mode;
wherein the edge AI accelerator includes:
a data memory unit storing the processed first feature maps, the second feature maps or an emotion recognition result and provides relevant commands to reset or input data to the processor;
a processing array unit composed of a plurality of processing units, each containing a first multiply-accumulate (MAC) unit to perform computations for convolutional computing and matrix-vector product, and performing parallel processing of the first feature maps and the second feature maps;
a convolutional neural network (CNN) acceleration unit including a plurality of convolutional layers and a plurality of pooling layers, the convolutional layers performing a convolution operation on the first feature maps, controlling the convolution operation in the processing array unit to generate a convolution data, and the pooling layers performing a pooling operation on the convolution data to reduce computational complexity, controlling the pooling operations in the processing array unit to generate a pooled data;
a Long Short-Term Memory (LSTM) unit performing recursive processing on the pooled data, extracting temporal features in each processing unit to generate a recursive data; and
a fully connected unit performing regression prediction, while the recursive data performing a matrix-vector product operation within each processing unit of the processing array unit, controlling the multiplication operation of the processing array unit to obtain the emotion recognition result.

2. The multimodal emotion recognition system according to claim 1, wherein the first feature extraction module includes a short-time Fourier transformer and a baseline normalization processor; wherein the short-time Fourier transformer extracts frequency signals from at least one physiological signal using a non-overlapping Hamming window to extract features; the baseline normalization processor scales each data point based on a mean value using the following Equation 1,
$${Spec}_{i}^{{′}_{ch}} = \frac{{Spec}_{i}^{{′}_{ch}} - {baseline}^{ch}}{{baseline}^{ch}} , \qquad Equation 1$$
where Spec and Spec′ represent the data before and after baseline normalization processing, respectively; ch is the EEG channel, and i denotes the number of subjects.

3. The multimodal emotion recognition system according to claim 1, wherein the second feature extraction module includes a plurality of feature values between peak-to-peak intervals of ECG and peak-to-peak intervals of PPG, and the feature values includes SDNN, NN50, PNN50, RMSSD, δₓ, 6′, γx, γ′, SDSD, SD1, SD2, SD12, PTTₘₑₐₙ, PTT_{std}, PPGₘₑₐₙ, PPG_{std}, LF, HF, LF/HF, and HF/TP.

4. The multimodal emotion recognition system according to claim 3, wherein through a Generalized Learning Vector Quantization (GLVQ) algorithm, the feature values are quantized and assigned to predefined categories, GLVQ represents the differences between categories as a weight matrix, enabling the nearest prototype classifier to adjust the weights to distinguish the emotion recognition result.

5. The multimodal emotion recognition system according to claim 1, wherein an input value to the nearest prototype classifier consists of a training dataset and test dataset, where the training dataset is W={Z₁, Z₂, . . . , Z_{c}}, with Zᵢ is the set of prototype representing in ith classes, and an output value of the nearest prototype classifier including a distance between a test sample and all training samples, a membership value, and a predicted label.

6. The multimodal emotion recognition system according to claim 5, wherein the membership value is calculated through a membership function, which is defined by the following formula,
$${μ}_{i} ( x ) = \frac{1 / {\vert {x}_{test} - {Z}_{i} \vert}^{2 / ( m - 1 )}}{{\sum }_{j = 1}^{c} ( 1 / {\vert {x}_{test} - {Z}_{j} \vert}^{2 / ( m - 1 )}} . \qquad Equation 2$$

7. The multimodal emotion recognition system according to claim 6, wherein the output of the fully connected unit is multiplied by a membership degree of each category during the calculation process of the fuzzification algorithm to obtain a multiplied value; the membership degree, calculated using Formula 2, is derived from the second feature maps of the electrocardiogram (ECG) signals and the photoplethysmogram (PPG) signals; and the multiplied value is then adjusted through a softmax layer to generate the emotion recognition result.

8. The multimodal emotion recognition system according to claim 1, wherein the processing array unit includes 3×10 processing units, capable of processing a 3×N filter and a 12×N the first feature map or the second feature map simultaneously in a single cycle, where N represents the data length; the signal input method uses a horizontal broadcast and a diagonal broadcast, allowing convolution data to be fed to a plurality of processing units for product accumulation operations within one cycle to generate a product accumulation result; and the product accumulation result is then passed to the previous level of processing unit through a vertical shift register for product accumulation operations in the next cycle, ultimately reaching an upper accumulator to obtain a convolution operation result.

9. The multimodal emotion recognition system according to claim 1, wherein the LSTM unit contains a plurality of memories, to store weights corresponding to the first feature maps, the second feature maps and hidden state weights; the LSTM unit performs a gate parameter computation on the pooled data, and the gate parameter computation is conducted within each processing array unit to generate the recursive data, which is then processed through an activation function to compute a current state (Ct) value and a hidden state (Ht) value.

10. The multimodal emotion recognition system according to claim 9, wherein the fully connected unit includes the activation function, which can be either a Rectified Linear Unit (ReLU) function or a Softmax function, when the calculation of the previous layer of the fully connected unit is not the final layer, the fully connected unit uses the ReLU function as the activation function, and If the fully connected unit is performing the final layer's calculation, the activation function switches to Softmax function; the result of the ReLU function can be directly determined by the sign bit and is output to the respective memory units.
